(19) United States
(12) Patent Application Publication
(10) Pub. No.: US 2001/0052351 A1
(43) Pub. Date: Dec. 20, 2001

(54) METHOD FOR CLEANING SEMICONDUCTOR WAFER HAVING COPPER STRUCTURE FORMED THEREON

(76) Inventors: BRIAN J. BROWN, PALO ALTO, CA (US); MADHAVI CHANDRACHOOD, SUNNYVALE, CA (US); FRITZ REDEKER, FREMONT, CA (US)

Correspondence Address: PATENT COUNSEL, APPLIED MATERIALS INC, LEGAL AFFAIRS DEPARTMENT, P O BOX 450A, SANTA CLARA, CA, 95052

(21) Appl. No.: 09/163,582

(22) Filed: Sep. 30, 1998

Related U.S. Application Data
(60) Provisional application No. 60/102,345, filed on Sep. 29, 1998.

(51) Int. Cl. C23G 1/04; C03C 23/00; C23G 1/16; B08B 3/08

(52) U.S. Cl. 134/2; 134/3; 134/28; 134/29

(57) ABSTRACT

A cleaning solution and method for removing copper contaminants, slurry particles and other contaminants from the polished surfaces of copper interconnect structures are provided. The cleaning solution comprises various combinations of a plurality of the following components: a zeta potential modifier, a pH adjuster, a contamination remover and a corrosion inhibitor. A corrosion inhibitor remover also may be provided to remove the corrosion inhibitor following contamination removal with the cleaning solution. The cleaning solution components may be pre-mixed or the components may be delivered individually, either simultaneously or sequentially in any order, to the surface of a semiconductor wafer during cleaning.

This application claims priority from U.S. provisional application Serial No. ______, filed Sep. 29, 1998 (AMAT Docket No. 2720/CMP/RKK).

### FIELD OF THE INVENTION

The present invention relates to semiconductor devices employing metal layer interconnects and more particularly to an improved cleaning solution for cleaning a semiconductor wafer containing a copper structure following chemical mechanical polishing (CMP) of the semiconductor wafer.

### BACKGROUND OF THE INVENTION

A typical integrated circuit contains a plurality of metal pathways to provide electrical power for powering the various semiconductor devices comprising the integrated circuit, and to allow these semiconductor devices to share/exchange electrical information. Within integrated circuits, metal layers are stacked on top of one another by using intermetal or “interlayer” dielectrics that insulate the metal layers from each other. Typically, however, each metal layer must form electrical contact to an additional metal layer. Metal-layer-to-metal-layer electrical contact is achieved by etching a hole (i.e., a via) in the interlayer dielectric that separates the first and second metal layers, and by filling the resulting hole or via with a metal (i.e., a plug) to create an interconnect as described further below.

The use of copper in place of aluminum as the interconnect material for semiconductor devices has grown in popularity due to copper's lower resistivity. Unlike aluminum, however, copper is highly mobile in silicon dioxide and may, as a result of infiltration of copper atoms into the dielectric, create leakage paths through a device's various dielectric layers. Copper atoms also can cause electrical defects in silicon.

Copper atom contamination is particularly prevalent during copper metal interconnect formation (e.g., damascene interconnect formation) between the steps of copper plug formation within the interlayer dielectric (e.g., to connect to the first metal layer) and deposition of a subsequent dielectric layer (e.g., a subsequent interlayer dielectric) as explained with reference to FIG. 1. FIG. 1 is side elevational view of a partially completed copper interconnect 11 (“partial interconnect 11”). The partial interconnect 11 comprises a first metal layer 13, an interlayer dielectric 15 (e.g., silicon dioxide) formed on the first metal layer 13 and having a via 17 and line 18 etched therein to expose the first metal layer 13, a barrier layer 19 deposited on the side walls of the via 17, the line 18 and the exposed portion of the first metal layer 13, and a copper plug 20 and copper line 21 deposited within the via 17 and line 18 over the barrier layer 19 so as to fill the via 17 and the line 18 with copper.

The partial interconnect 11 has been planazarized via a CMP step as is well known in the art. As a result of planarization, the top surface of the interlayer dielectric contains a plurality of copper contaminants 23 (e.g., copper atoms, copper oxide, etc.) liberated from the copper plug and line material during planarization. These copper contaminants are highly mobile within in the interlayer dielectric 15 and may create numerous deleterious current leakage paths through the interlayer dielectric (e.g., forming via-to-via leakage paths). As such, copper contaminants should be removed from the interlayer dielectric, wafer edge and wafer backside prior to deposition of the next dielectric layer to avoid incorporation of the copper contaminants within the copper interconnect.

In addition to copper contaminants, the top surface of the interlayer dielectric 15 and the top surface of the copper line 21 contain slurry particles from the CMP process, and other contaminants that must be removed prior to deposition of the next dielectric layer. A difficulty arises in removing slurry particles and other contaminants from the polished surfaces of the partial interconnect 11 without affecting the quality of the copper line 21 (e.g., etching the copper line, forming a copper oxide layer thereon, etc.), and thus the quality of an interconnect formed therefrom.

Accordingly, a need exists for a method of removing copper contaminants, slurry particles and other contaminants from the polished surfaces of interconnect structures without adversely affecting the interconnect formed therefrom.

### SUMMARY OF THE INVENTION

To address the needs of the prior art an inventive post-CMP cleaning solution and a method for using the cleaning solution are provided. The cleaning solution comprises various combinations of a plurality of the following components:

(1) a zeta potential modifier for changing the zeta potential magnitude of slurry particles to aid in their removal and the removal of other contaminants from semiconductor wafer surfaces;

(2) a pH adjuster for adjusting the pH of the cleaning solution to reduce undesirable etching of a copper structure (e.g., a copper plug) to a tolerable level (i.e., to substantially reduce etching);

(3) a contamination remover for removing copper contaminants from a surface of a semiconductor wafer (e.g., the polished surface of the interlayer dielectric); and

(4) a corrosion inhibitor for reducing undesirable etching of a copper structure during cleaning of the wafer.

A corrosion inhibitor remover also may be provided to remove the corrosion inhibitor from the copper surface following contamination removal via the contamination remover. Additionally, a substantial component of the cleaning solution preferably comprises deionized water.

The zeta potential modifier changes the zeta potential magnitude of slurry particles (e.g., alumina slurry particles) by affecting the electrical charge of each slurry particle. Preferably the zeta potential modifier increases the repulsive charge of the slurry particles to prevent the slurry particles from binding together due to Van der Wals forces. With the zeta potential of each particle thus modified, slurry particles are less likely to stick together, load scrubber brushes (e.g., PVA brushes)or remain on semiconductor wafer surfaces. The zeta potential modifier also may etch a small amount of copper from the interlayer dielectric on the wafer's frontside, bevel and backside, as well as any copper oxides and hydroxides (e.g., formed during CMP or during transfer of the semiconductor wafer to a cleaning apparatus following CMP) that might otherwise load a scrubber brush.

The zeta potential modifier preferably comprises a weak acid such a hydrocarboxyl acid, and most preferably citric acid. The zeta potential modifier preferably is present in an amount between 0.1-1.0 weight percent, and most preferably 0.3 weight percent.

The pH adjuster buffers the cleaning solution to a relatively constant pH despite small variations in the zeta potential modifier and other cleaning solution constituents, and prevents etching of the copper structure (e.g., copper plug) that can result if a cleaning solution having too high or too low a pH is employed during cleaning. As well, the pH adjuster can increase the electrical charge (e.g., negative charge) of slurry particles and thus aid the removal of slurry particles from semiconductor wafer surfaces and aid the prevention of brush loading due to slurry particle agglomeration. The pH adjuster also may etch a small amount of copper from the interlayer dielectric of the wafer's frontside, bevel and backside, and can reduce the formation of copper oxides during cleaning of the semiconductor wafer with the cleaning solution.

The pH adjuster preferably comprises a weak base such as an amine, and most preferably comprises ammonium hydroxide, ammonium fluoride and tetramethyl ammonium hydroxide. The pH adjuster preferably is present in an amount between 0.005-0.1 weight percent, and most preferably 0.025 weight percent. The exact concentration depends on the concentration of zeta potential modifier within the cleaning solution. However, a pH adjuster concentration sufficient to adjust the pH within the range from 4 to 7 is preferred. A cleaning solution pH of about 5 is most preferred.

The contamination remover removes copper contaminants from the interlayer dielectric and other surfaces of the semiconductor wafer (e.g., the wafer's frontside, bevel and backside). Preferably the contamination remover comprises a dielectric etchant that undercuts copper contaminants on the surface of, or embedded near the surface of a dielectric (e.g., the interlayer dielectric) by removing a thin layer of the dielectric. The contamination remover preferably comprises hydrofluoric acid but may comprise other dielectric etchants such as buffered hydrofluoric acid and hydrogen peroxide. Preferably the contamination remover is present in an amount between 0.1-2, and most preferably 0.5, weight percent.

The corrosion inhibitor protects copper structures from being etched (e.g., to prevent excessive roughing of copper surfaces) by the zeta potential modifier, the pH adjuster and the contamination remover, and may or may not be required depending on the type of, and concentration of the contamination remover employed. The preferred corrosion inhibitor is benzotraixole (BTA). However, melanic acid or other similar 10+ carbon chain chemicals may be employed. The corrosion inhibitor preferably is present in an amount less than about 1 weight percent, and most preferably about 0.1 weight percent.

The corrosion inhibitor remover, if employed, removes the corrosion inhibitor from copper surfaces following contamination removal (e.g., via the contamination remover). The corrosion inhibitor typically renders surfaces hydrophobic leading to residues of non-volatile residue during drying and can affect via resistance and therefore preferably is removed. The corrosion inhibitor may be removed via a rinse step with a fluid containing the corrosion inhibitor remover following semiconductor wafer cleaning, or via any similar process (e.g., a spray, a rinse tank, megasonic tank, a Marangoni spin or lift process, etc.). The corrosion inhibitor may be a solvent such as isopropyl alcohol or an oxidant such as hydrogen peroxide. Any chemical that removes the corrosion inhibitor without damaging the other surfaces of the semiconductor wafer may be used.

The inventive cleaning solution may contain two or more of the above listed components. For instance, the following five cleaning solution combinations are preferred:

(1) a first cleaning solution comprising a zeta potential modifier and a pH adjuster;

(2) a second cleaning solution comprising a zeta potential modifier, a pH adjuster and a contamination remover;

(3) a third cleaning solution comprising a zeta potential modifier, a pH adjuster, a contamination remover and a corrosion inhibitor;

(4) a fourth cleaning solution comprising a pH adjuster and a contamination remover; and

(5) a fifth cleaning solution comprising a pH adjuster, a contamination remover and a corrosion inhibitor.

The above described cleaning solutions remove copper contaminants, slurry particles and other contaminants from the polished surfaces of interconnects, without adversely affecting the interconnect itself.

### BRIEF DESCRIPTION OF THE DRAWINGS

FIG. 1 is a side elevational view of a partially completed copper interconnect as previously described;

FIG. 2A-C are sequential, side elevational views of the partial interconnect of FIG. 1 during cleaning in accordance with a first sequential cleaning method of the present invention;

FIGS. 3A-C are sequential, side elevational views of the partial interconnect of FIG. 1 during cleaning in accordance with a second, simultaneous cleaning method of the present invention; and

FIG. 4 is a side elevational view of a PVA brush scrubber 31.

### DETAILED DESCRIPTION OF THE PREFERRED EMBODIMENTS

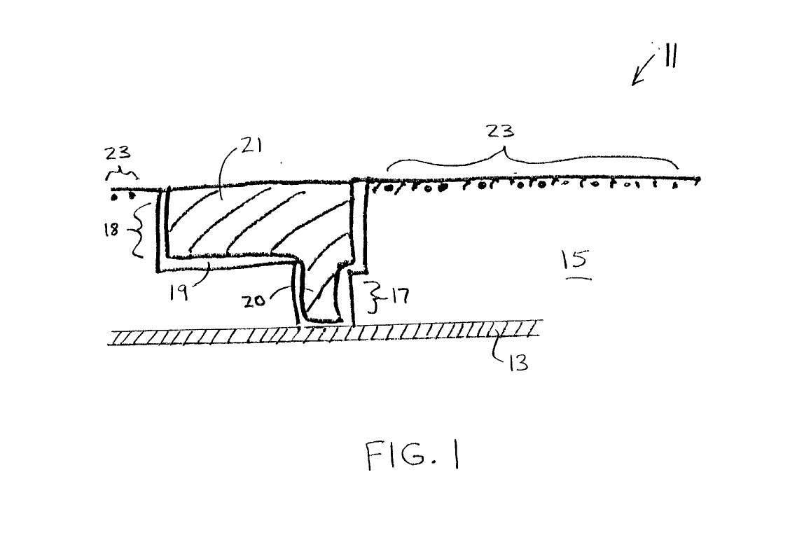

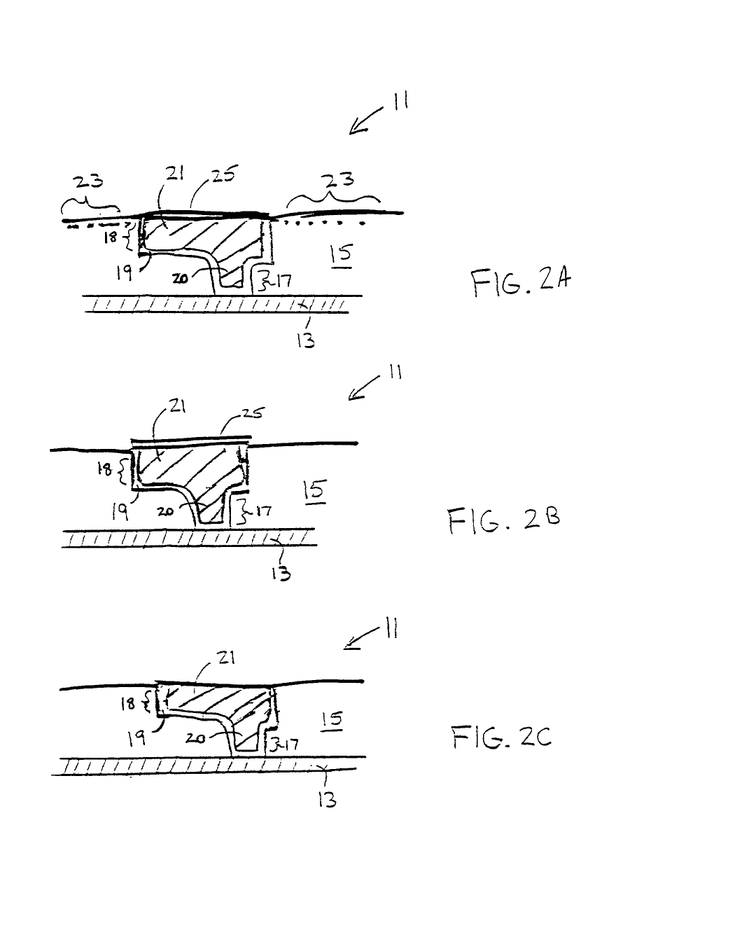

FIG. 2A-C are sequential, side elevational views of the partial interconnect 11 of FIG. 1 during cleaning in accordance with a first, sequential cleaning method of the present invention. With reference to FIG. 2A, following CMP of the partial interconnect 11, the interlayer dielectric 15 is contaminated with a plurality of copper contaminants 23. To remove the copper contaminants, the semiconductor wafer on which the partial interconnect 11 is formed (not shown), is exposed to a corrosion inhibitor such as BTA. The corrosion inhibitor forms a passivating layer 25 over the copper line 21 (and any other similar copper structures). The passivating layer 25 protects the copper line 21 from attack by the contamination remover.

Following passivation of the copper line 21, the partial interconnect 11 is exposed to a contamination remover such as hydrofluoric acid. The contamination remover etches the dielectric layer 15 (in which the copper contaminants 23 are imbedded), effectively removing the copper contaminants 23 therefrom as shown in FIG. 2B.

Following contamination removal via the contamination remover, the partial interconnect 11 is rinsed with a corrosion inhibitor remover such as isopropyl alcohol to remove the corrosion inhibitor from the copper line 21 as shown in FIG. 2C. Thereafter, the next dielectric layer (not shown) may be deposited on the copper line 21 to form a completed copper interconnect that does not suffer from copper-contaminant-induced leakage current paths.

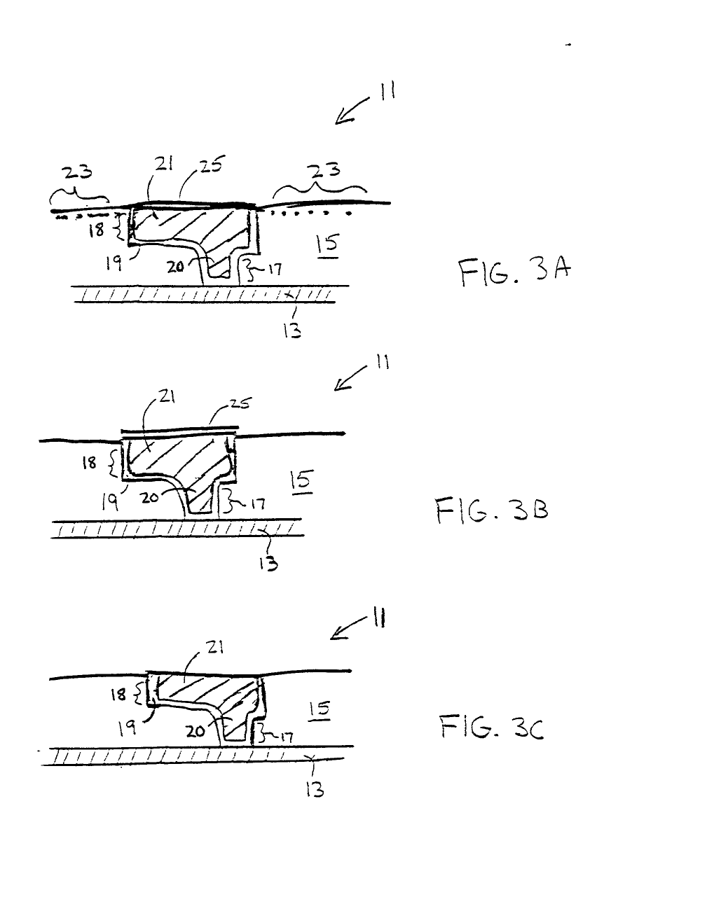

FIGS. 3A-C are sequential, side elevational views of a partial interconnect 11 of FIG. 1 during cleaning in accordance with a second, simultaneous cleaning method of the present invention. With reference to FIG. 3A, following CMP of the partial interconnect 11, the interlayer dielectric 15 is contaminated with a plurality of copper contaminants 23. To remove the copper contaminants, the semiconductor wafer on which the partial interconnect 11 is formed (not shown), is simultaneously exposed to a corrosion inhibitor such as BTA and a contamination remover such as hydrofluoric acid. The corrosion inhibitor forms a passivating layer 25 over the copper line 21 (and any other similar copper structures). The passivating layer 25 protects the copper line 21 from attack by the contamination remover. The contamination remover etches the dielectric layer 15 (in which the copper contaminants 23 are imbedded), effectively removing the copper contaminants 23 therefrom as shown in FIG. 3B.

Following contamination removal via the contamination remover, the partial interconnect 11 is rinsed with a corrosion inhibitor remover such isopropyl alcohol to remove the corrosion inhibitor from the copper line 21 as shown in FIG. 3C. Thereafter, the next dielectric layer (not shown) may be deposited on the copper line 21 to form a completed copper interconnect that does not suffer from copper contaminant induced leakage current paths.

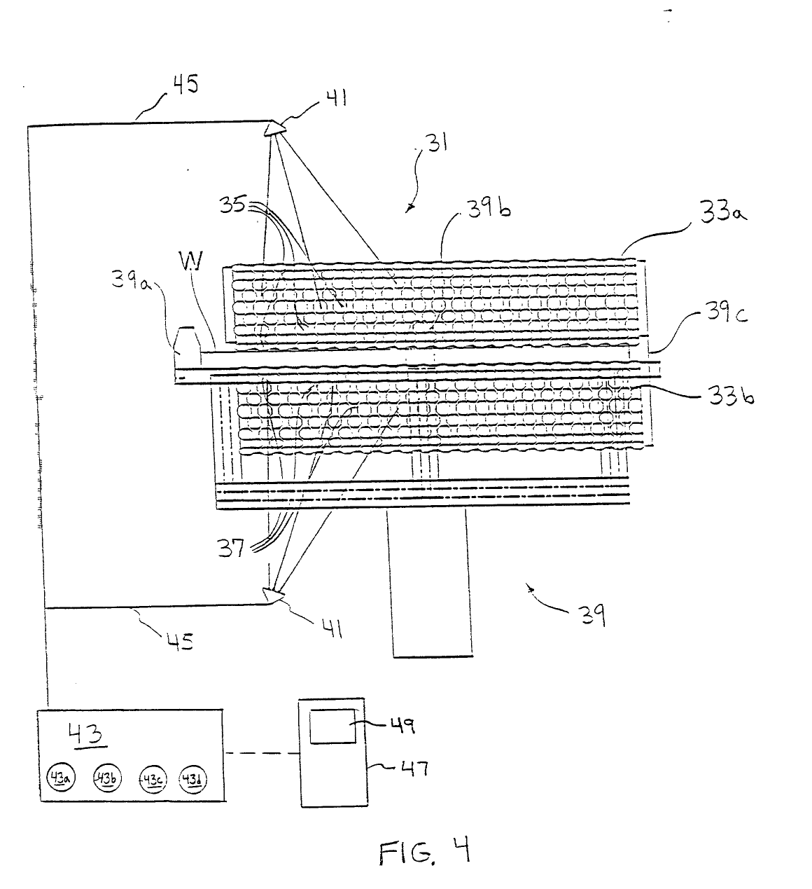

FIG. 4 is a side elevational view of a PVA brush scrubber 31 (“scrubber 31”). The scrubber 31 comprises a pair of PVA brushes 33a, 33b. Each brush comprises a plurality of raised nodules 35 across the surface thereof, and a plurality of valleys 37 located among the nodules 35. The scrubber 31 also comprises a platform 39 for supporting a wafer W and a mechanism (not shown) for rotating the pair of PVA brushes 33a, 33b. The platform 39 comprises a plurality of spinning mechanisms 39a-c for spinning the wafer W.

As further shown in FIG. 4, a plurality of spray nozzles 41 coupled to a source 43 of the inventive cleaning solution via a supply pipe 45, are positioned to spray the inventive cleaning solution at the surfaces of the wafer W during wafer scrubbing.

The source 43 of cleaning solution comprises a first source 43a of a zeta potential modifier, a second source 43b of a pH adjuster, a third source 43c of a corrosion inhibitor, and a fourth source 43d of a contamination remover. Each of the sources 43a-d is operatively coupled to the supply pipe 45. A controller 47 is coupled to the cleaning solution source 43, and contains a program 49 for controlling the supply of cleaning solution delivered to the pair of PVA brushes 33a, 33b, so as to achieve the desired sequence, quantity and combination of zeta potential modifier, pH adjuster, contamination remover and corrosion inhibitor. Preferably the controller 47 is also operatively coupled to the pair of PVA brushes 33a, 33b and to a wafer handler (not shown) for loading and unloading wafers from the scrubber 31, and the program 49 controls the scrubber 31 so as to operate as described below.

In operation, the PVA brushes 33a, 33b are initially in an open position (not shown), a sufficient distance from each other so as to allow a wafer to be inserted therebetween. Thereafter, the wafer W to be cleaned is positioned between the PVA brushes 33a, 33b and the brushes assume a closed position (FIG. 4), sufficiently close to each other so as to both hold the wafer W in place therebetween and to exert a force on the wafer surfaces sufficient to achieve effective cleaning. Mechanisms (not shown) for moving the brushes 33a, 33b between the open and closed positions are well known in the art and are therefore not further described herein.

Once the brushes 33a, 33b are in the closed position, a spinning mechanism (not shown) is engaged and the brushes 33a, 33b begin to spin. Preferably the brushes 33a, 33b spin in opposite directions applying forces to the wafer W in a first direction (e.g., into the page) while the wafer W is rotated either clockwise or counterclockwise via the spinning mechanisms 39a-c.

The top and bottom surfaces of the wafer W are cleaned of slurry residue when contacted by the nodules 35 of the brushes 33a, 33b, respectively. As the brushes 33a, 33b rotate, the inventive cleaning solution is sprayed on the top and bottom surfaces of the wafer W via the spray nozzles 41 to achieve the inventive cleaning process described above.

Specifically, the controller 47 causes a zeta potential modifier to be pumped from the first source 43a of zeta potential modifier through the supply pipe 45 to the spray nozzles 41, and causes the supply to continue until the zeta potential of the slurry particles has been sufficiently modified to deter slurry particles from binding together on wafer surfaces or within the PVA brushes 33a, 33b.

Thereafter, the controller 47 causes a pH adjuster to be pumped from the second source 43b of pH adjuster through the supply pipe 45 to the spray nozzles 41, and causes the supply to continue until the pH of the cleaning solution is adjusted to about 5.

Thereafter, the controller 47 causes a corrosion inhibitor to be pumped from the third source 43c of corrosion inhibitor through the supply line 45 to the spray nozzles 41, and causes the supply to continue until the copper structures on the wafer W are sufficiently protected from etching during wafer cleaning.

Thereafter, the controller 47 causes a contamination remover to be pumped from the fourth source 43d of contamination remover through the supply line 45 to the spray nozzles 41, and causes the supply to continue until a sufficient amount of contamination remover is present to etch copper contaminants from the interlayer dielectric as described above. Alternatively, deionized water may be pumped in between chemistries to prevent mixing; or, several brush nodules could be run in series with one chemistry per nodule.

Following wafer cleaning, the wafer is transferred from the PVA brush scrubber to a rinsing apparatus (e.g., a spray tank, a megasonic tank, a Marangoni spin or lift process, etc.—not shown) wherein a source of corrosion inhibitor remover (not shown) is employed to remove corrosion inhibitor from the semiconductor wafer W.

The foregoing description discloses only the preferred embodiments of the invention, modifications of the above disclosed apparatus and method which fall within the scope of the invention will be readily apparent to those of ordinary skill in the art. For instance, the cleaning solution may be employed as a pre-mixed cleaning solution or the components of the cleaning solution may be delivered individually, either simultaneously or sequentially in any order, to the surface of a semiconductor wafer during cleaning.

Although a scrubber is the preferred apparatus for performing the inventive method, other apparatuses may be employed. The cleaning chemistries described herein can be coupled to bath cleaning apparatus such as a megasonic cleaning tank, and a controller can be programmed to supply the chemistries in the desired sequence so as to perform the steps described above.

Similarly the cleaning chemistries can be coupled to a polishing apparatus such as a chemical mechanical polisher and the polisher's controller can be programmed to supply the chemistries in the desired sequence. A conventional polisher could be modified to replace metal parts that contact the cleaning chemistries with parts made or coated with a material such as a plastic which resists corrosion by the chemistries. Thus as used herein a semiconductor wafer cleaning apparatus includes scrubbers, tank cleaners, polishers, spin rinsers and the like. The scrubbing apparatus may supply the chemistries through the brushes, may drip the chemistries onto the brushes, etc.

Accordingly, while the present invention has been disclosed in connection with the preferred embodiments thereof, it should be understood that other embodiments may fall within the spirit and scope of the invention, as defined by the following claims.

The invention claimed is:

1. A cleaning solution for cleaning a semiconductor wafer having a copper structure formed thereon, comprising:
a zeta potential modifier for increasing the magnitude of a zeta potential of any slurry particles present on a semiconductor wafer being cleaned with the cleaning solution; and
a pH adjuster for adjusting a pH of the cleaning solution to substantially reduce the etching of a copper structure formed on a semiconductor wafer being cleaned with the cleaning solution.

2. The cleaning solution of claim 1 wherein the zeta potential modifier comprises an acid.

3. The cleaning solution of claim 2 wherein the zeta potential modifier comprises a hydrocarboxyl acid.

4. The cleaning solution of claim 3 wherein the zeta potential modifier comprises citric acid.

5. The cleaning solution of claim 1 wherein the pH adjuster is present in an amount that adjusts the pH of the cleaning solution to within the range of 4 to 7.

6. The cleaning solution of claim 5 wherein the pH adjuster is present in an amount that adjusts the pH of the cleaning solution to about 5.

7. The cleaning solution of claim 1 wherein the pH adjuster comprises a base.

8. The cleaning solution of claim 7 wherein the pH adjuster composes a base selected from the group consisting of ammonium hydroxide, ammonium fluoride and tetramethyl ammonium hydroxide.

9. The cleaning solution of claim 1 wherein the cleaning solution further comprises a contamination remover for removing copper contaminants from a surface of a semiconductor wafer being cleaned with the cleaning solution.

10. The cleaning solution of claim 9 wherein the contamination remover comprises hydrofluoric acid.

11. The cleaning solution of claim 9 wherein the cleaning solution further comprises a corrosion inhibitor for reducing etching of a copper structure formed on a semiconductor wafer being cleaned with the cleaning solution.

12. The cleaning solution of claim 11 wherein the corrosion inhibitor comprises a material selected from the group consisting of benzotraixole and melanic acid.

13. The cleaning solution of claim 1 wherein the cleaning solution further comprises a corrosion inhibitor for reducing etching of a copper structure formed on a semiconductor wafer being cleaned with the cleaning solution.

14. A cleaning solution for cleaning a semiconductor wafer having a copper structure formed thereon, comprising:
a pH adjuster for adjusting a pH of the cleaning solution to substantially reduce etching of a copper structure formed on a semiconductor wafer being cleaned with the cleaning solution; and
a contamination remover for removing copper contaminants from a surface of a semiconductor wafer being cleaned with cleaning solution.

15. The cleaning solution of claim 14 further comprising a corrosion inhibitor for reducing etching of a copper structure formed on a semiconductor wafer being cleaned with the cleaning solution.

16. A method of cleaning a semiconductor wafer having a copper structure formed thereon, comprising:
providing a semiconductor wafer to be cleaned, the semiconductor wafer having a copper structure formed thereon;
providing a cleaning solution comprising:
a zeta potential modifier for increasing the magnitude of a zeta potential of any slurry particles present on the semiconductor wafer; and
a pH adjuster for adjusting a pH of the cleaning solution to substantially reduce etching of the copper structure; and
cleaning the semiconductor wafer with the cleaning solution.

17. The method of claim 16 wherein the zeta potential modifier comprises an acid.

18. The method of claim 16 wherein the pH adjuster comprises a pH adjuster present in an amount that adjusts the pH of the cleaning solution to within the range of 4 to 7.

19. The method of claim 16 wherein the pH adjuster comprises a base.

20. The method of claim 16 wherein the cleaning solution further comprises a contamination remover for removing copper contaminants from a surface of the semiconductor wafer.

21. The method of claim 20 wherein the cleaning solution further comprises a corrosion inhibitor for reducing etching of the copper structure by the cleaning solution.

22. The method of claim 21 further comprising providing a corrosion inhibitor remover for removing the corrosion inhibitor from a surface of the semiconductor wafer.

23. The method of claim 16 wherein the cleaning solution further comprises a corrosion inhibitor for reducing etching of the copper structure by the cleaning solution.

24. The method of claim 23 further comprising providing a corrosion inhibitor remover for removing the corrosion inhibitor from a surface of the semiconductor wafer.

25. The method of claim 16 wherein cleaning the semiconductor wafer comprises providing a semiconductor wafer cleaning apparatus and cleaning the semiconductor wafer with the semiconductor wafer cleaning apparatus.

26. A semiconductor device fabricated by the method of claim 16.

27. A method of cleaning a semiconductor wafer having a copper structure formed thereon, comprising:
providing a semiconductor wafer to be cleaned, the semiconductor wafer having a copper structure formed thereon;
providing a cleaning solution comprising:
a pH adjuster for adjusting a pH of the cleaning solution to substantially reduce etching of the copper structure; and
a contamination remover for removing copper contaminants from a surface of the semiconductor wafer; and
cleaning the semiconductor wafer with the cleaning solution.

28. The method of claim 27 further comprising a corrosion inhibitor for reducing etching of the copper structure by the cleaning solution.

29. The method of claim 28 further comprising providing a corrosion inhibitor remover for removing the corrosion inhibitor from a surface of the semiconductor wafer.

30. The method of claim 27 wherein cleaning the semiconductor wafer comprises:
providing a semiconductor wafer cleaning apparatus; and
cleaning the semiconductor wafer with the semiconductor wafer cleaning apparatus.

31. A semiconductor wafer cleaning system comprising:
a source of cleaning solution, the cleaning solution comprising:
a zeta potential modifier; and
a pH adjuster;
a semiconductor wafer cleaning apparatus for cleaning a semiconductor wafer with the cleaning solution; and
a cleaning solution supply system coupled to the source of cleaning solution and to the semiconductor wafer cleaning apparatus for supplying cleaning solution to the semiconductor wafer cleaning apparatus.

32. The semiconductor wafer cleaning system of claim 31 wherein the source of cleaning solution comprises:
a source of zeta potential modifier; and
a source of pH adjuster; and
wherein the cleaning solution supply system further comprises a mechanism for supplying the zeta potential modifier and the pH adjuster to the semiconductor wafer cleaning apparatus premixed.

33. The semiconductor wafer cleaning system of claim 31 wherein the source of cleaning solution comprises:
a source of zeta potential modifier; and
a source of pH adjuster; and
wherein the cleaning solution supply system further comprises a mechanism for supplying the zeta potential modifier and the pH adjuster to the semiconductor wafer cleaning apparatus individually and simultaneously.

34. The semiconductor wafer cleaning system of claim 31 wherein the source of cleaning solution comprises:
a source of zeta potential modifier; and
a source of pH adjuster; and
wherein the cleaning solution supply system further comprises a mechanism for supplying the zeta potential modifier and the pH adjuster to the semiconductor wafer cleaning apparatus individually and sequentially.

35. The semiconductor wafer cleaning system of claim 31 wherein the cleaning solution further comprises a contamination remover.

36. The semiconductor wafer cleaning system of claim 35 wherein the cleaning solution further comprises a corrosion inhibitor.

37. The semiconductor wafer cleaning system of claim 36 further comprising a source of corrosion inhibitor remover for supplying corrosion inhibitor remover to the semiconductor wafer cleaning apparatus following the cleaning of a semiconductor wafer with the cleaning solution.

38. A semiconductor wafer cleaning system comprising:
a source of cleaning solution, the cleaning solution comprising:
a pH adjuster; and
a contamination remover;
a semiconductor wafer cleaning apparatus for cleaning a semiconductor wafer with the cleaning solution; and
a cleaning solution supply system coupled to the source of cleaning solution and to the semiconductor wafer cleaning apparatus for supplying cleaning solution to the semiconductor wafer cleaning apparatus.

39. The semiconductor wafer cleaning system of claim 38 wherein the cleaning solution further comprises a corrosion inhibitor.

40. The semiconductor wafer cleaning system of claim 39 further comprising a source of corrosion inhibitor remover for supplying corrosion inhibitor remover to the semiconductor wafer cleaning apparatus following the cleaning of a semiconductor wafer with the cleaning solution.

41. The semiconductor wafer cleaning system of claim 31 wherein the semiconductor wafer cleaning apparatus comprises a scrubber having a brush.

42. The semiconductor wafer cleaning system of claim 38 wherein the semiconductor wafer cleaning apparatus comprises a scrubber having a brush.

43. The cleaning solution of claim 7 wherein the pH adjuster comprises an amine.
